(19) United States
(12) Patent Application Publication
(10) Pub. No.: US 2025/0190988 A1
(43) Pub. Date: Jun. 12, 2025

(54) SECURE VOICE PAYMENTS FOR CALL-BASED TRANSACTIONS

(71) Applicant: Journey.ai, Denver, CO (US)

(72) Inventors: Gary Robert COMAN, Copper Canyon, TX (US); Alan WRIGHT JOHNSON, JR., Denver, CO (US); Michael Joseph FRENDO, Boulder, CO (US); Alexander John SHOCKLEY, Denver, CO (US); Shmuel SHAFFER, Palo Alto, CA (US); James M. BEHMKE, Boston, MA (US)

(21) Appl. No.: 18/969,116

(22) Filed: Dec. 4, 2024

Related U.S. Application Data
(60) Provisional application No. 63/605,632, filed on Dec. 4, 2023.

(51) Int. Cl. G06Q 20/40; G06Q 20/02; G06Q 20/38

(52) U.S. Cl. CPC G06Q 20/4014; G06Q 20/027; G06Q 20/3829

(57) ABSTRACT

The techniques herein are directed generally to improving voice and digital payment systems for secure payments, and, more particularly, to securing voice payments for transactions taking place over a phone call. That is, the techniques herein facilitate secured payments over voice channels for transactions between a caller (or a callee) and an agent of the selling organization, such as a call center agent. The techniques herein specifically ensure compliance with the Payment Card Industry Data Security Standard (PCI DSS) while reducing the complexity and cost of deploying PCI-compliant payment systems.

### PRIORITY INFORMATION

This application claims priority to U.S. Provisional Application No. 63/605,632, filed on Dec. 4, 2023, entitled SECURE VOICE PAYMENTS FOR CALL-BASED TRANSACTIONS, by Coman, et al., the contents of which being incorporated herein by reference in its entirety.

### TECHNICAL FIELD

The present disclosure relates generally to secure data management systems, and, more particularly, to secure voice payments for call-based transactions.

### BACKGROUND

Credit card transactions are prone to fraud. A party receiving credit card information may misuse the card information resulting in fraudulent charges to the credit card owner or to the issuer of the card. The misuse of the card may range from simply failing to secure the card information all the way to deliberately making unauthorized purchases using the disclosed card information or else selling the card information to criminals.

The payment card industry developed the Payment Card Industry Data Security Standard (PCI DSS) to better control cardholder data and reduce credit card fraud. The PCI DSS is an information security standard used to handle credit cards from major card brands. To ensure compliance the standard provides mechanisms for companies to perform self-assessment, companywide internal security assessment, as well as external qualified security assessment. Since most credit card companies cover damages from fraud, compliance with the PCI DSS may have financial ramifications for all companies involved including credit card holders, credit card issuers, and sellers who accept credit card payments.

To ensure a fraud-free environment, all of the threat vectors related to credit card transactions need to be addressed. These include, but are not limited to, ensuring that human beings do not have access to card information and ensuring that the person using a credit card is the legitimate owner of the card.

Digital collection of credit card information eliminated the need for human being involvement in the transactions. For example, credit card readers may convey the card information directly to the computer of the seller thus eliminating the human involvement. Similarly, when a purchase is made over a phone, an agent of the seller may push a link (e.g., a uniform resource locator (URL) link that directs a user to an internet based platform) with a payment form to the phone or computer of the buyer. The buyer may enter his credit card information to the form and return it directly to the computer of the seller without the seller or his agent being involved in the credit card transaction. Examples for such solutions include Apple Pay and Google Pay.

While a digital solution solves the issue, recent surveys have shown that 80% of respondents would prefer to connect directly to a real, human customer service agent, rather than talk to any kind of automated Chatbot or other automated call-responding service.

Various solutions have been developed for users who prefer to speak their credit card information. All of these solutions attempt to prevent fraud by ensuring that the seller or his agent does not have access to the credit card information of the buyer. However, each one of the existing solutions has its own limitations.

For example, a first attempt to solve credit card fraud issues starts with a voice call is established between a buyer and a business place. In this solution, when the buyer needs to provide credit card information to complete the transaction, the seller or its agent transfers the caller to an intelligent virtual agent (IVA) system (i.e., an automated version of a live customer service agent) which is programmed to collect the caller's credit card information. While the seller is no longer on the call and cannot hear the buyer's credit card information, if the buyer encounters any issue during his interaction with the IVA, the seller/agent is oblivious to the issue and cannot provide any support. If the buyer wants to talk with the seller/agent he needs to place a new call to the seller. If the seller employs a call center to handle incoming calls, the caller may be connected with another agent who is not familiar with the transaction that the buyer attempted to complete.

In another solution to solve credit card fraud issues, a voice call is again established between a buyer and a business place, but now when the buyer needs to provide credit card information to complete the transaction, the seller or its agent invokes a third-party application (such as PCI Pal's Agent Assist), which uses Dual Tone Multi-Frequency (DTMF) masking technology. With this feature, contact center agents can capture cardholder information securely, while maintaining the conversation with the customer at all times. Because the agent never hears the credit card information, the feature provides a secure means of processing payments by phone without bringing contact center environments under the scope of Payment Card Industry Data Security Standard (PCI DSS). This integration ensures that sensitive payment card information remains secured throughout customer interactions. The third-party application thus captures the details of the interaction between the buyer and the seller, but blocks the credit card information from reaching both the agent and the seller's environment. The customer's voice is allowed through in the event they need to communicate with the agent. However, because the implementation of this feature relies heavily on features implemented in a central office (CO) which may change, maintenance of this implementation may be a challenge.

Still other solutions to the problem may suffer from similar issues. Also, while the issue of ensuring the person providing the credit card information is the rightful owner of the card was solved by applications like Google Pay or Apple Pay, users such as credit companies and sellers would welcome other more cost effective solutions. What is needed, therefore, is an easy-to-maintain solution that meets PCI DSS requirements without imposing high cost for the users.

### SUMMARY

The techniques herein are directed generally to improving voice and digital payment systems for secure payments, and, more particularly, to securing voice payments for transactions taking place over a phone call. That is, the techniques herein facilitate secured payments over voice channels for transactions between a caller (or a callee) and an agent of the selling organization, such as a call center agent. The techniques herein specifically ensure compliance with the Payment Card Industry Data Security Standard (PCI DSS) while reducing the complexity and cost of deploying PCI-compliant payment systems.

Other embodiments of the present disclosure may be discussed in the detailed description below, particularly from the perspective of specific devices within the system herein, and the summary above is not meant to be limiting to the scope of the invention herein.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate examples of secure voice payment systems;

FIG. 2 illustrates another example of a secure voice payment system;

FIGS. 3A-3B illustrate examples of secure voice payment systems specifically in accordance with one or more embodiments of the present disclosure;

FIG. 4 illustrates an example of a secure digital payment system;

FIG. 5 illustrates an example of a secure digital payment system specifically in accordance with one or more embodiments of the present disclosure;

FIGS. 6A-6B illustrate an example procedure for operation of a secure voice payment system;

FIGS. 7A-7B illustrate an example procedure for operation of a secure digital payment system;

FIG. 8 illustrates an example simplified computer network;

FIG. 9 illustrates an example of a computing device;

FIGS. 10A-10B illustrate further simplified examples of secure voice payment systems;

FIG. 11 illustrates an example procedure for secure voice payments for call-based transactions; and

FIG. 12 illustrates another example procedure for secure voice payments for call-based transactions.

### DESCRIPTION OF EXAMPLE EMBODIMENTS

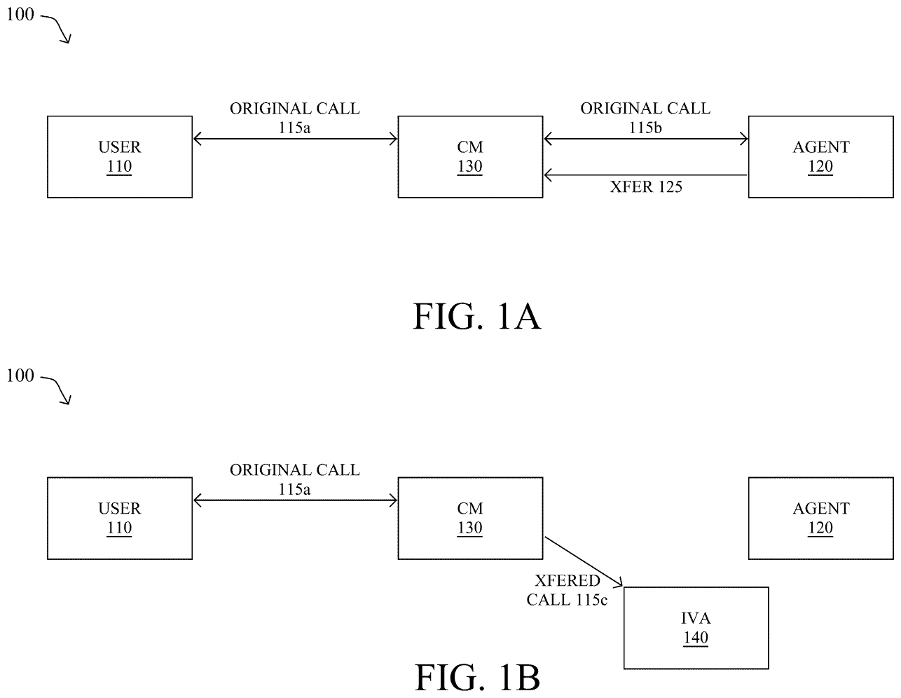

FIG. 1A provides an example 100 of a secure voice payment system. A user or buyer 110, is in a voice discussion with a seller 120 (or an agent of the seller). The call usually passes via a call manager, CM 130. The CM can be located in the central office (CO) and/or the premises of the seller, and/or in the cloud. If the user initiates the call, call leg 115a of the original call is established first and then the call manager establishes call leg 115b establishing an end-to-end connection. If the agent initiates the call, call leg 115b of the original call is established first and then the call manager establishes call leg 115a, establishing an end-to-end connection. Upon completion of the discussion between the user and the agent, the agent issues a transfer command 125 to the CM 130. Notably, those skilled in the art would recognize that in some VoIP systems the call path may be established end-to-end between the caller and the callee (e.g., between the user and the agent) rather than via the call manager. It is noted that the call leg 115a, the call leg 115b, and/or the call leg 115c may be referred to herein in the alternative as “communication channels” (e.g., a first communication channel, a second communication channel, a third communication channel, etc.).

FIG. 1B provides an example of the secure voice system after the CM received the transfer command 125. Upon receiving the transfer command, the CM establishes a connection between the user and the interactive voice agent, IVA 140, (which may be referred to herein as a “secure agent”) by establishing call leg 115c. Call leg 115b is disconnected as to prevent the agent from being able to hear the credit card information (or other sensitive information) that the user enters.

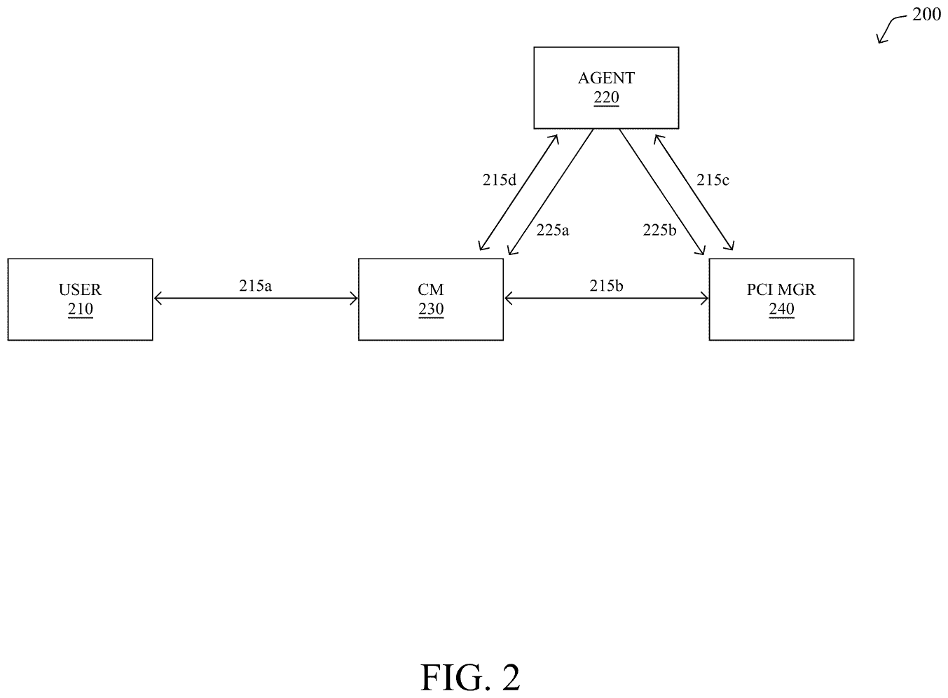

FIG. 2 provides another example 200 of a secure voice payment system. A user or a buyer 210, is in voice discussion with a seller 220 (or an agent of the seller). The call may pass via a call manager, CM 230, and may pass via a PCI manager 240. The CM and PCI manager can be located in the central office (CO) and/or the premises of the seller, and/or in the cloud. If the user initiated the call, call leg 215a of the original call is established first and then the call manager establishes call leg 215d, establishing an end-to-end connection. In another example implementation, a call manager established the call via PCI manager 240 by establishing call legs 215b and 215c. Upon completion of the discussion between the user and the agent, the agent issues command 225a and/or 225b, to the CM 230 and or the PCI manager. Upon receiving the commands, the call is routed via the PCI manager which is configured to filter out any credit card information from reaching the agent while continuing to facilitate voice discussion between the agent and the user. As mentioned above, however, the configuration of this feature and the interface between the PCI manager and the CM may present maintenance issues. The PCI manager is usually kept in the voice path as to facilitate filtering out and/or preventing any confidential information from reaching the agent.

On the other hand, the techniques herein facilitate secured payments over voice channels for transactions between a buyer and a seller (e.g., between a caller/callee and an agent of the selling organization, such as a call center agent), while ensuring compliance with the Payment Card Industry Data Security Standard (PCI DSS) with reduced cost and complexity.

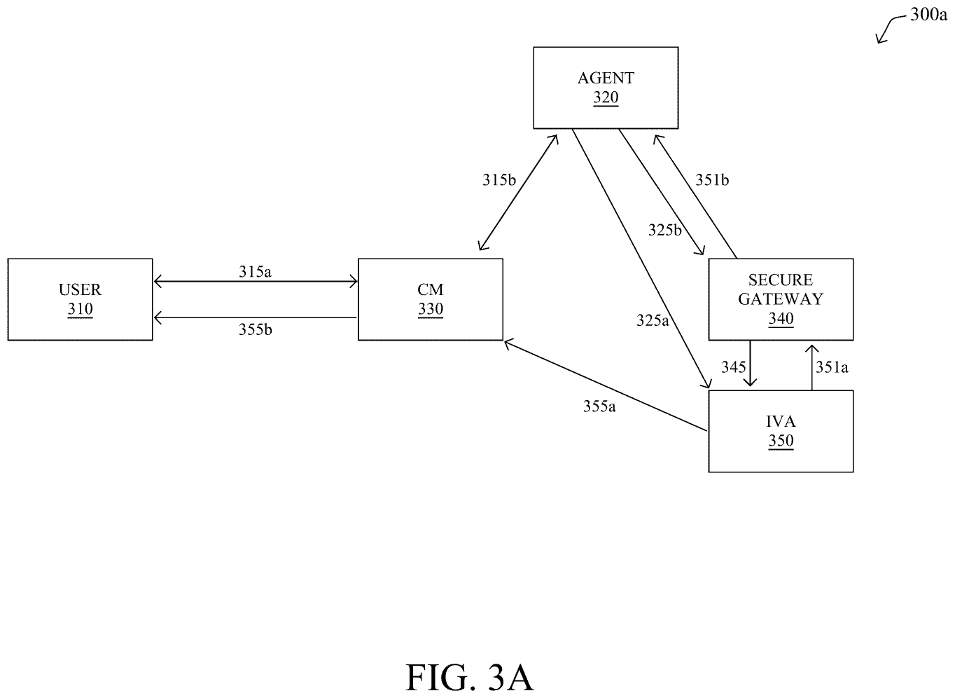

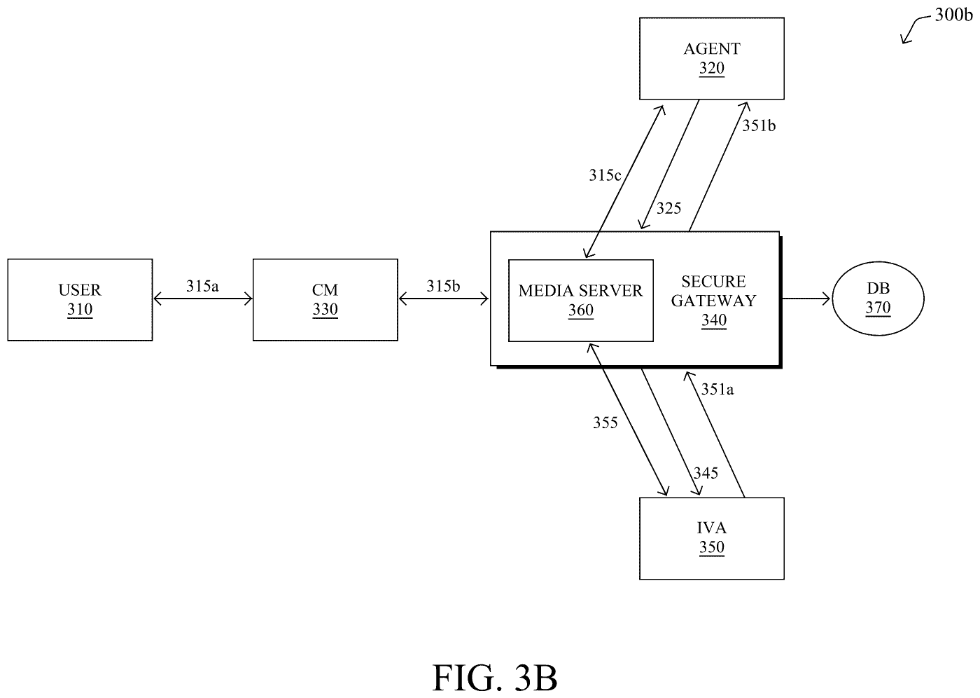

Operationally, FIG. 3A provides an example of a secure voice payment system 300a in accordance with the techniques herein. A user or a buyer 310 is in a voice discussion with a seller 320 (or an agent of the seller), similar to the systems above. The call may pass via a call manager, CM 330, and may pass via a secure gateway, e.g., a Journey® gateway, such as secure gateway 340. by providing user attestation without exposing sensitive user information to other parties, such as the CM 130 and/or the agent (e.g., a seller 120).

The CM 330 and/or secure gateway manager can be located in the central office (CO) and/or the premises of the seller, and/or in the cloud. If the user initiated the call, call leg 315a of the original call is established first and then the call manager establishes call leg 315b, establishing an end-to-end connection between the user and the agent. In another example implementation, if the agent initiates the call, the call manager establishes the call by first establishing call legs 315b and then call leg 315a. Upon completion of the discussion between the user and the agent, the agent issues command 325a directly to the IVA 350, or indirectly via commands 325b to the secure gateway 340 which would issue the command 345 to the IVA 350. Upon receiving the command, the IVA 350 places a call 355a, 355b to the user who is talking with the agent. The agent instructs verbally (or otherwise) that the user should accept the incoming call and place the call with the agent on hold. Upon doing that, a call is established between the buyer 310 and the IVA 350. Since the call between the agent (e.g., the seller 320) and the buyer 310 is placed on hold, the agent cannot hear any information, including, but not limited to, credit card information that the user may disclose to the IVA.

During the session between the user and the IVA, the IVA 350 uses message 351a to update the secure gateway about the status of the interaction between the user or buyer 310 and the IVA 350. The secure gateway provides the update to the agent using message 251b. In another example implementation the IVA bypasses the secure gateway and updates the agent directly (not shown in the figure for sake of simplicity). Examples, without limitations, of such status messages may include an indication that progress is ok, an indication that the user is experiencing an issue at a specific step, an indication that the user overcame issue and is progressing well, an indication that the user is not able to make progress, an indication that a transaction is successfully completed, an indication that the user has indicated that he/she would like to speak with the agent, etc.

In another example implementation, the status information is stored in a database and may be conveyed to the agent either directly from the IVA or via the database. In such implementations, the system may use the information to place a call to a user who may have gotten frustrated and hung up on the session with the IVA, or was otherwise disconnected from the session.

As long as the session between the user and the IVA is progressing properly, the call of the agent stays on hold. However, if the IVA indicates to the secure gateway and/or to the agent that the user is experiencing issues or that the user would like to talk with the agent, either the agent or the secure gateway automatically, may issue a command to the IVA to disconnect the call between the IVA and the user. As the call between the IVA and the user disconnects, the original call between the user and the agent which was placed on hold may be activated facilitating communication between the user and the agent.

In another example implementation, rather than advising the IVA to hang up on the user, the IVA advises the user to toggle between the active call and the call on hold. When the user does that the system connects the user with the agent who is able to help the user and explain to him or her how he or she could proceed with his active session with the IVA.

In one example implementation the advice to the user to toggle between the two calls is issued by the agent. In another example implementation the advice to toggle between the two calls is provided automatically by the IVA.

If the session between the user and the IVA completes successfully and the user does not request to talk to the agent, the secure gateway automatically disconnects the active call as well as the call which was placed on hold. In another specific implementation, the IVA always hangs up upon completion of a successful payment session, which results in the agent being again connected with the user.

FIG. 3B provides another example of a secure voice payment system 300b in accordance with the present disclosure. A user or a buyer 310, is in a voice discussion with a seller 320 or an agent of the seller. The call usually passes via a call manager, CM 330, and via a gateway, e.g., the secure gateway 340, and specifically via a media server 360, and continues to the agent. The CM and/or secure gateway manager can be located in the central office (CO) and/or the premises of the seller, and/or in the cloud. The media server can be a module of the secure gateway or be located in an independent server. If the user initiated the call, call leg 315a of the original call is established first and then the call manager establishes call leg 315b to the media server. Upon receiving the call from the user, the media server connects the call, via call leg 315c, to an agent who is available to receive the call (or places the call in a queue until an agent frees up). This establishes an end-to-end connection between the user and the agent. In another example implementation if the agent initiates the call, the call manager established the call by first establishing call legs 315c, followed by call leg 315b and then call leg 315a. Upon completion of the discussion between the user and the agent, the agent informs the user that he will be transferred to a secure payment system which the agent cannot listen to and issues a command 325 to the secure gateway. The secure gateway initiates a call between the media server 360 and the IVA 350 connecting the user to an IVA session via call leg 355, and places the call leg 315c between the agent and the media server on hold. At the end of this operation, a call is established between the user or buyer 310 and the IVA 350. Since the call leg between the agent or seller 320 and the media server 360 is placed on hold, the agent cannot hear any payment information exchanged between the user and the IVA, including, but not limited to, credit card information that the user may disclose to the IVA.

During the session between the user and the IVA, the IVA 350 uses message 351a to update the secure gateway about the status of the interaction between the user or buyer 310 and the IVA 350. The secure gateway provides the update to the agent using message 351b. The status may also be stored in a database 370 for future use. In another example implementation the IVA bypasses the secure gateway and updates the agent directly (not shown in the figure for sake of simplicity). Examples, without limitations, of such status messages may include {progress ok, user is experiencing an issue at a specific step, user overcame issue and is progressing well, user not able to make progress, transaction successfully completed, user indicated that he would like to speak with the agent, etc.}.

In another example implementation, the status information is stored in a database 370 and may be conveyed to the agent either via the secure gateway, directly from the IVA, or via the database. The system may use the information to place a call to a user who may have gotten frustrated and hung up on the session with the IVA.

As long as the session between the user and the IVA is progressing properly, the call leg between the agent and the media server stays on hold. However, if the IVA indicates to the secure gateway and/or to the agent that the user is experiencing issues or that the user would like to talk with the agent, either the agent, via command 325, or the secure gateway automatically, issues a command to the media server to place call leg 355 to the IVA on hold and connect the user with the agent by activating call leg 315c. In one example implementation, the IVA announces to the user that his call is being transferred back to the agent for help. In yet another example implementation the IVA may play a message to the users asking him whether he would like to be transferred back to the agent.

In one example implementation user may ask to be transferred to the agent by issuing an appropriate command to the IVA.

If the session between the user and the IVA completes successfully and the user does not request to talk to the agent, the secure gateway may automatically disconnect the call of the user. In another example implementation, the user is always connected to the agent to provide an upsell opportunity.

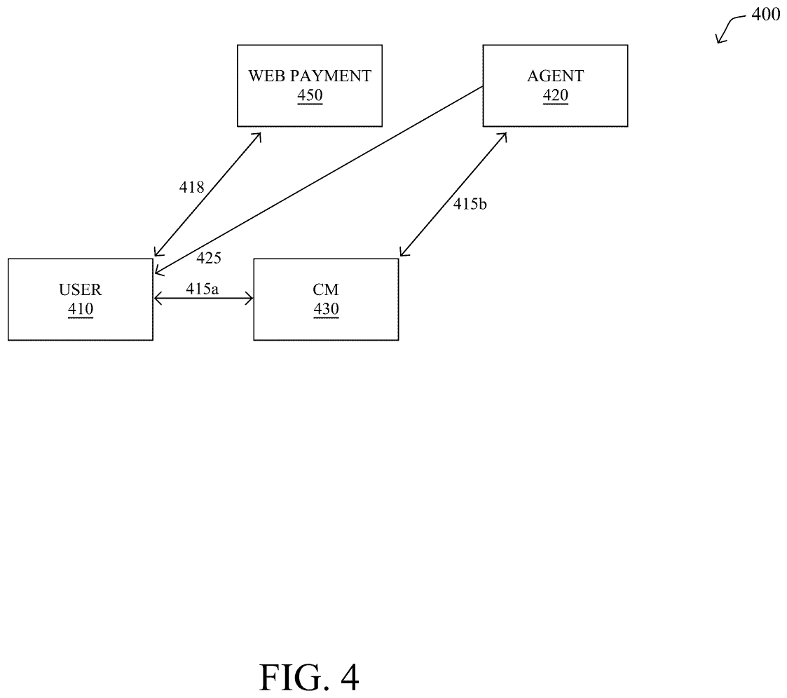

FIG. 4 provides example illustration 400 of a secure digital payment system. A user or a buyer 410, is in a voice discussion with a seller 420 or an agent of the seller. The call usually passes via a call manager, CM 430. The CM can be located in the central office (CO) and/or the premises of the seller, and/or in the cloud. If the user initiates the call, call leg 415a of the original call is established first and then the call manager establishes call leg 415b establishing an end-to-end connection. If the agent initiates the call, call leg 415b of the original call is established first and then the call manager establishes call leg 415a, establishing an end-to-end connection. Upon completion of the discussion between the user and the agent, the agent triggers an action 425 that sends a link of a digital payment to the user's device. The user's device may be a phone and the link may be sent via a text message, as a message to a payment application, etc. Similarly, the link may be sent via an email message and the payment may be done by the user using his phone, tablet, etc. Upon clicking on the link, the user is directed to a website 450 which presents the user with a form to enter the payment information. The user then enters the payment information 418 into the form. As the user enters the payment information he/she is able to talk with the agent, however, the agent cannot see the information that the user enters into the web form.

In another example implementation, the user may use a digital wallet. The digital wallet helps prevent fraudulent usage of payment information by ensuring that the user is a valid owner of the payment information. For example, the user may use digital wallets such as Apple Pay or Google Pay, select a specific credit card or other means of payment, and present the mobile device to a digital pay-point. However, while the digital wallet reduces a fraudulent use of payment information, the service comes with a cost which may increase the cost of doing business.

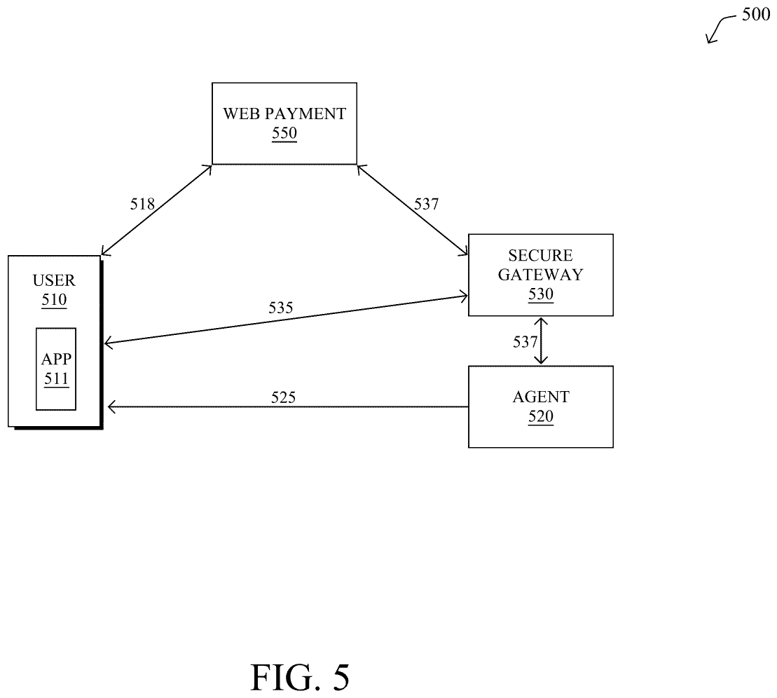

FIG. 5 provides an example of a secure digital payment system 500 in accordance with the techniques herein. A user or a buyer 510, is in a voice discussion with a seller or an agent of the seller 520. For sake of simplicity the process of establishing the voice connection including the CM and the call legs are omitted. The user's identity (e.g., an attested identity) is established and validated by exchange 535 between an application 511 (“App”) which resides on his device in collaboration with the secure gateway 530. A system including the application and a secure gateway to ensure the validity of user's attested identity was described in greater details in US applications/patents, each of which are incorporated into the present application by reference in their entirety:
US Patent Application Publication No. 2020-0259845 PROVIDING ACCESS CONTROL AND IDENTITY VERIFICATION FOR COMMUNICATIONS WHEN RECEIVING A COMMUNICATION FROM AN ENTITY TO BE VERIFIED;
US Patent Application Publication No. 2020-0259827 PROVIDING ACCESS CONTROL AND IDENTITY VERIFICATION FOR COMMUNICATIONS WHEN INITIATING A COMMUNICATION FROM AN ENTITY TO BE VERIFIED;
US Patent Application Publication No. US 2020-0259828 PROVIDING ACCESS CONTROL AND IDENTITY VERIFICATION FOR COMMUNICATIONS WHEN INITIATING A COMMUNICATION TO AN ENTITY TO BE VERIFIED;
US Patent Application Publication No. 2020-0259829 PROVIDING ACCESS CONTROL AND IDENTITY VERIFICATION FOR COMMUNICATIONS WHEN RECEIVING A COMMUNICATION AT AN ENTITY TO BE VERIFIED;
US Patent Application Publication No. 2020-0259830 PROVIDING ACCESS CONTROL AND IDENTITY VERIFICATION FOR COMMUNICATIONS BETWEEN INITIATING AND RECEIVING DEVICES.

Upon completion of the discussion between the user and the agent, the agent triggers an action via link 525 that sends a link of a digital payment to the user's device. The link may be sent directly to the user's device via link 525 via the secure gateway using link 537, via text server, email server, etc. The specifics of how the information is sent are not central to this application.

The user's device may be a phone and the link may be sent via a text message, as a message to a payment application, etc. Similarly, the link may be sent via an email message and the payment may be done by the user using his phone, tablet, etc. Upon clicking on the link, the user is directed to a website 550 or to any other payment server which presents the user with a form to enter the payment information. The user then enters the payment information 518 into the form.

Upon receiving the payment information, the payment server, e.g., the web payment server (e.g., website 550) exchanges information with the secure gateway 530 and validates that the user is a valid owner (e.g., an attested valid owner) of the information he entered. For example, the name entered as part of the payment information matches the name on the credit card that the user entered. If the names match, the payment is processed without any delay. However, if the names do not match, the agent may be informed and take an appropriate action such as ask the user to use a valid payment credit card, or alternatively mark the transaction as suspicious.

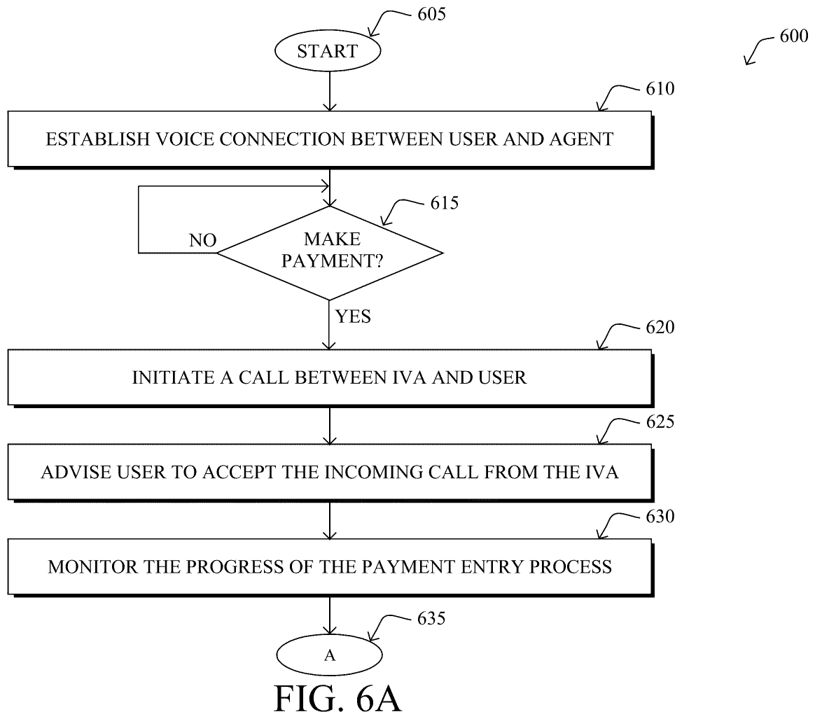

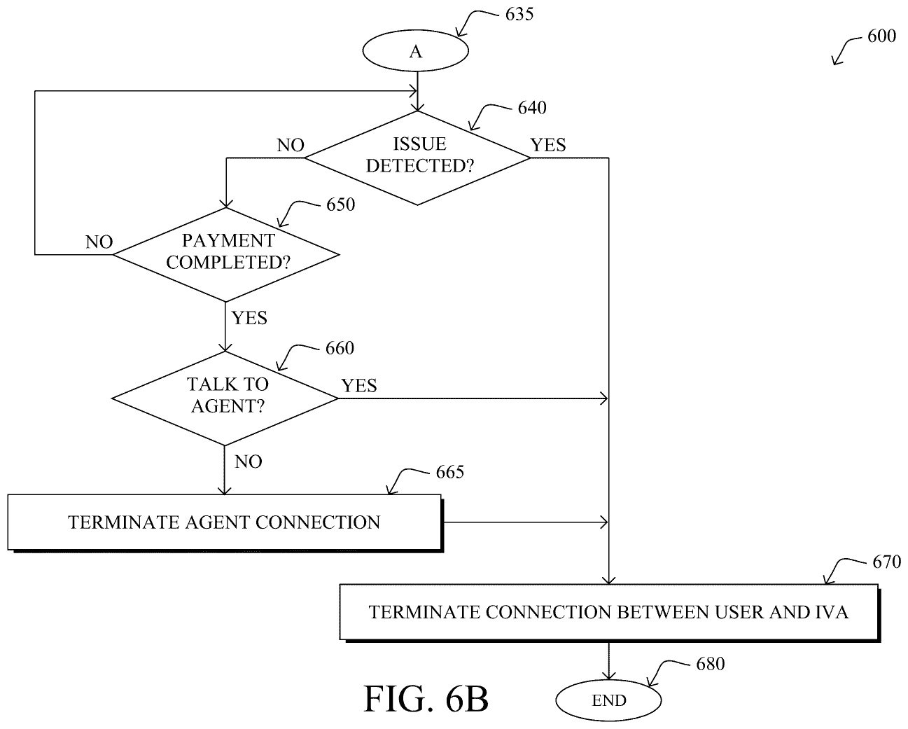

FIGS. 6A-6B provide an example flowchart 600 illustrating the operation of a secure voice payment system. The process starts at operation 605 and proceeds to operation 610 where a voice connection is established between the user and the agent. Operation 615 determines whether the user needs to make a payment. When the operation determines that the user is ready to make a payment the process proceeds to operation 620 where an outbound call between the IVA and the user is initiated. In operation 625 the agent instructs the user to answer the incoming call from the IVA. As the user answers the incoming call, the call between the agent and the user is placed on hold. As the user interacts with the payment system of the IVA, the IVA, in operation 630, provides an ongoing or periodical event driven, payment process progress status to the agent and/or the secure gateway. The process proceeds via connector operation “A” 635 to operation 640 which determines whether the payment process status is indicates that the user is experiencing issues with the payment application of the IVA.

If operation 640 determines that the user is experiencing an issue, in operation 670 the secure gateway or the agent may terminate the connection between the user and the IVA. As a result, the call between the agent and the user which was on hold is established and the user may talk with the agent to discuss and resolve the issue.

However, if operation 640 determines that there was no issue with the payment progress, the process proceeds to operation 650 which determines whether the payment process completed. If it did not, the process loops back to operation 640. However, if the payment process completed, operation 660 determines whether the caller wants to talk to the agent. If the user wants to talk to the agent, process continues to operation 670 where the secure gateway or the agent terminates the connection between the user and the IVA. As a result, the call between the agent and the user which was on hold is established and the user may talk with the agent. However, if the user does not need to talk with the agent, the process continues to operation 665 where the call of the agent is disconnected. The process continues to operation 670 where the call of the user is disconnected and the process ends in operation 680.

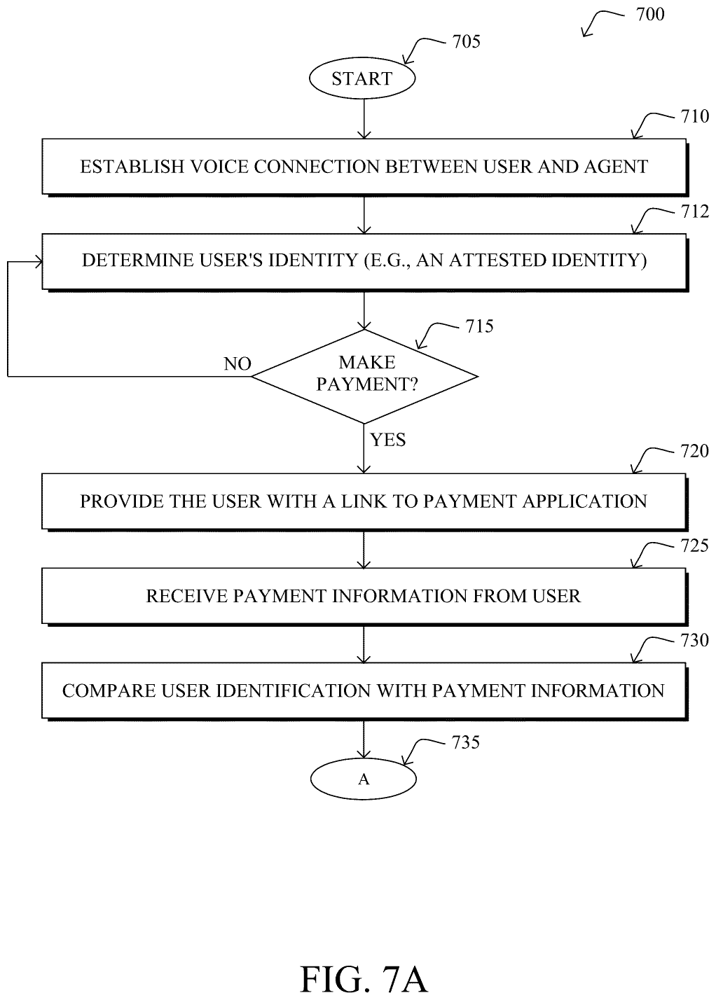

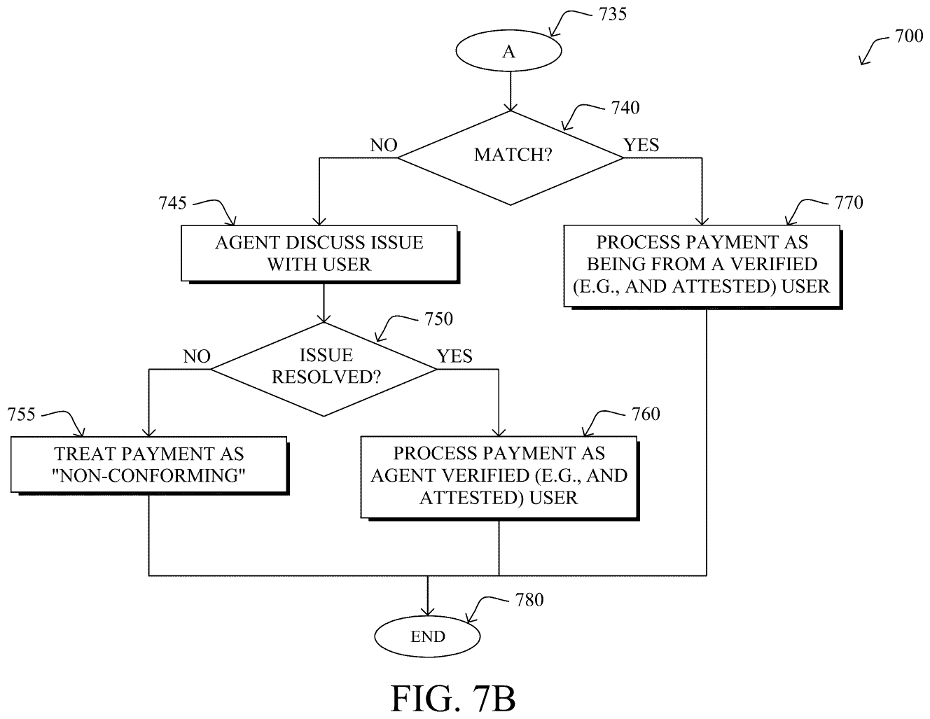

FIGS. 7A-7B provide an example of a flowchart 700 illustrating the operation of a secure digital payment system. The process starts at operation 705 and proceeds to operation 710 where a voice connection is established between the user and the agent. Operation 712 may determine the identity (e.g., attested) of the user, such as by using the methods described in the patents and disclosures described above, including a zero knowledge network described therein.

Operation 715 determines whether the user needs to make a payment. When the operation determines that the user is ready to make a payment the process proceeds to operation 720 where the user is provided by the agent or automatically by the secure gateway with a link to the payment system. In operation 725 the payment system receives payment information from the user. The payment information is compared with the identity of the user (which may be attested and/or obtained from the zero knowledge identity system) in operation 730. In one example implementation, the user presents the payment information to the payment application as encrypted information which is not readable by the system and the comparison is done between the two encrypted pieces of information, e.g., encrypted with the public key of the user.

The process continues via a connecting operation A 735 to operation 740 which examines whether the information such as the ID of the user which was determined in operation 712 matches the information provided in operation 725. Operation 740 determines whether the information matches. If the information matches, operation 770 processes the payment as being safe since it was submitted by an automatically fully verified (e.g., and thus attested) user. The process ends in operation 780.

However, if operation 740 determines that the information entered in operation 725 does not match the user's information which was obtained in operation 712, the method notifies the agent of the mismatch and in operation 745 the agent discusses the discrepancy with the user. If in operation 750 the agent is able to satisfactorily clarify the discrepancy and resolve the issue, the system marks the payment operation as being verified by the agent. In operation 760 such payments may get lesser scrutiny than unverified payments but higher scrutiny than payments for which the information was verified (e.g., thus attested, such as by a zero knowledge identity network). The process ends in operation 780.

However, if in operation 750 the agent is not able to clarify the discrepancy and resolve the issue, the system marks the payment operation as being submitted by an unverified user. In operation 755 such payments may get higher level of scrutiny. The process ends in operation 780.

It should be noted that while certain operations and steps within the flowcharts may be optional and the steps shown in the figures are merely examples for illustration, and certain other steps may be included or excluded as desired. Furthermore, while a particular order of the steps is shown, this ordering is merely illustrative, and any suitable arrangement of the steps may be utilized without departing from the scope of the embodiments herein. Moreover, the methods are described separately, certain steps from each procedure may be incorporated into one or more of the other methods and the various steps are not meant to be mutually exclusive.

In the detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

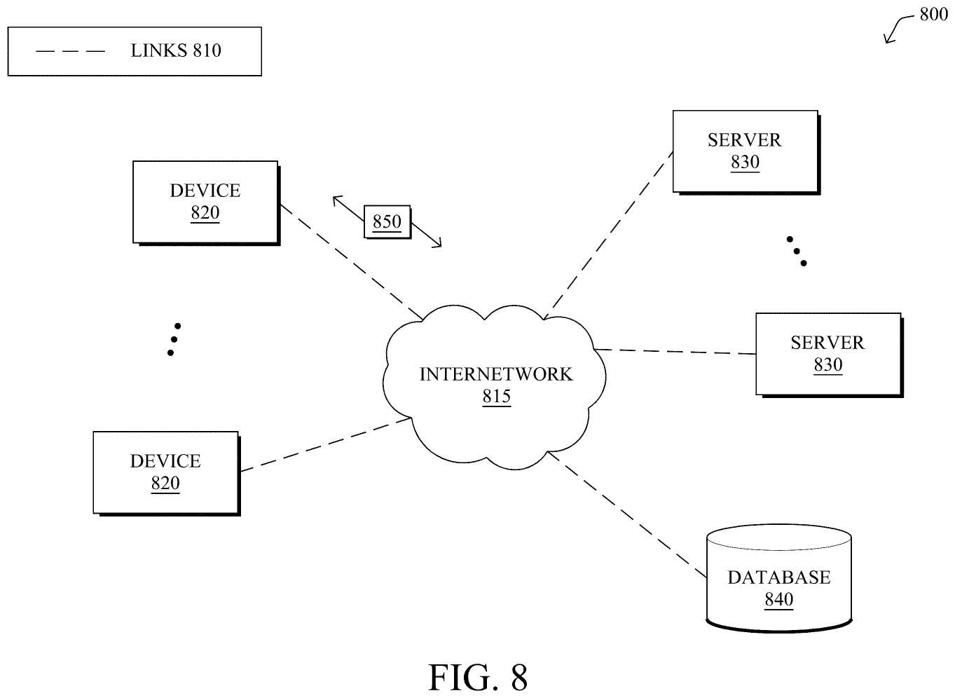

FIG. 8, in particular, illustrates an example, and simplified, computer network 800. As shown, computer network 800 may contain various devices communicating over links 810 and an internetwork 815, such as end devices 820, servers 830, databases 840 (which may be part of servers 830 or in communication with and under the control of servers 830), and other devices as will be appreciated by those skilled in the art. Data transmissions 850 (e.g., packets, frames, messages, transmission signals, etc.) may be exchanged among the nodes/devices of the computer network 800 using predefined communication protocols where appropriate over links 810. In this context, a protocol consists of a set of rules defining how the nodes interact and exchange information with each other.

Notably, the computer network 800 may comprise various individual networks intercommunicating with each other, such as LANs, WANs, cellular/LTE networks, PSTN, and so on, and may include any number of wired or wireless links between the devices, accordingly. Note also that while links 810 are shown generically interconnecting with the internetwork 815, any number of intermediate devices (e.g., routers, switches, firewalls, etc.) may actually make up the composition of the computer network 800 and internetwork 815, and the view shown herein is merely a simplified illustration.

End devices 820 may comprise different types of devices, such as, e.g., personal computers, desktop computers, laptop computers, mobile devices, tablets, smartphones, wearable electronic devices (e.g., smart watches), smart televisions, set-top devices for televisions, workstations, smart vehicles, terminals, kiosks, automated teller machines (ATMs), applications running on such devices, and so on, often interfacing with human users, though not necessarily. For instance, end devices 820 may also comprise drones, automated vehicles, artificial intelligence “beings” or robots, internet of things (IoT) devices, and so on.

Servers 830 and/or databases 840 may comprise singular servers and/or databases, server and/or database farms, cloud-based server and/or database services, network attached storage (SAN), and any other type or configuration of computing devices that provides computing and/or storage services as will be appreciated by those skilled in the art. Servers 830 and/or databases 840 may be centralized (i.e., processing and/or storage occurring on a single device or within a single location of devices) or distributed/decentralized (i.e., processing and/or storage occurring across multiple devices or across a plurality of locations). Notably, for example, servers 830 and/or databases 840 may be deployed on the premises of an enterprise or may be cloud-based.

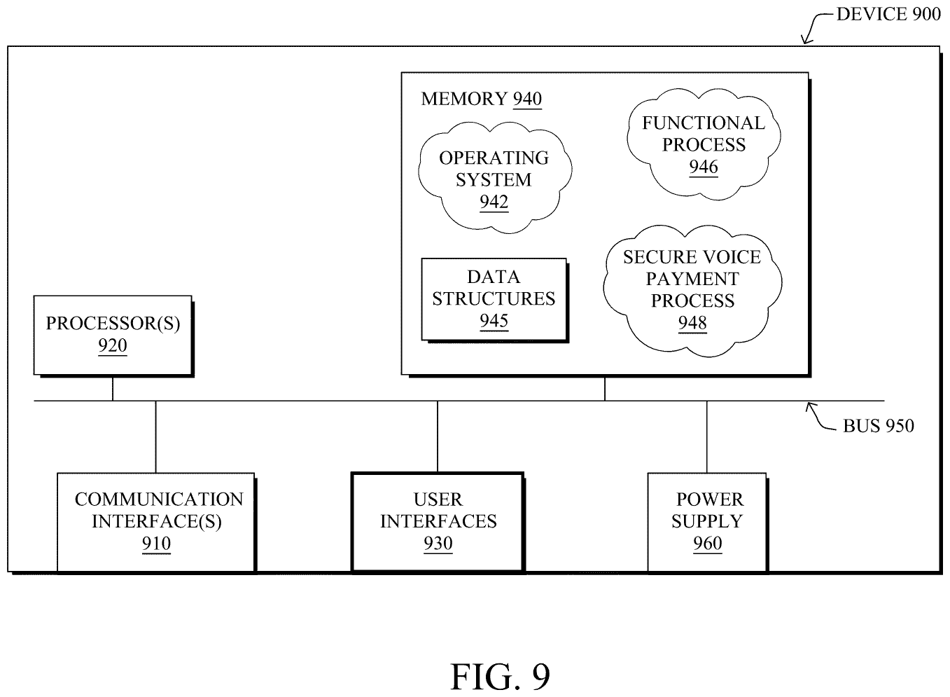

Additionally, FIG. 9 is a simplified schematic block diagram of an example computing device, such as device 900 (e.g., an apparatus), that may be used with one or more embodiments described herein (e.g., end device 820, servers 830, database 840, etc.). Illustratively, device 900 may generally include one or more communication interfaces 910, one or more processors (e.g., processor(s) 920), and a memory 940 interconnected by a system bus 950 or other dedicated circuitry, and is powered by a power supply system 960. Additionally, the device 900, where required, may comprise one or more user interfaces 930 configured to solicit and receive user input (input/output or “I/O” components, such as displays, keyboards, touchscreens, biometrics, and so on).

The one or more communication interfaces 910 include the mechanical, electrical, and signaling circuitry for communicating data over wired and/or wireless links of a communication network.

The memory 940 includes a plurality of storage locations that are addressable by the processor(s) 920 for storing software programs and data structures associated with the embodiments described herein. The processor(s) 920 may comprise necessary elements or logic adapted to execute the software programs and manipulate the data structures 945. An operating system 942, portions of which are typically resident in memory 940 and executed by the processor(s) 920, functionally organizes the device by, among other things, invoking operations in support of software processors and/or services executing on the device. Illustratively, these software processes and/or services may include one or more functional processes 946 (e.g., specific to functionality of the device), and an example “secure voice payment” process (process 948) that is configured to perform the operations described herein. Secure voice payment process (process 948) may be configured, for example, on each respective device of the system herein, such as on the secure gateway, the agent device, the IVA, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

While there have been shown and described illustrative embodiments, it is to be understood that various other adaptations and modifications may be made within the scope of the embodiments herein. For example, though the disclosure was often described with respect to “buyer” and “seller” banking examples, those skilled in the art should understand that this was done only for illustrative purpose and without limitations, and the techniques herein may be used for any secure communication environment between any two end-users/systems. For example, the communication of personally identifying information (PII) or other secure information may also utilize the techniques herein in a similar manner. Note, too, that in another embodiment, the agent may also trigger a ‘manager call’ or generally ‘another person’ call, such as at the request of the user/buyer or for verbal communication of private information (such as for user attestation, third-party authorizations, etc.), thus establishing a secondary call with a person, as opposed to an IVA, making a private connection away from the agent in general, and not merely to an IVA.

Furthermore, while the embodiments may have been demonstrated with respect to certain communication environments, physical environments, or device form factors, other configurations may be conceived by those skilled in the art that would remain within the contemplated subject matter of the description above. For example, various components and modules may be distributed in manners not specifically described or illustrated herein, but that provide functionally similar results (e.g., certain servers shown separately may be configured on a single server device within a computer network).

In addition, while the techniques have been described above in terms of one-to-one communication, the present disclosure may be applicable to one-to-many or many-to-one communications, such as conference calls, web conferences, and so on. For example, a presenter of a one-to-many conference with a plurality of end users may wish to pass secure information without exposing it to the remainder of the end-users. Example scenarios may include education, seminars, board meetings, shareholder meetings, business meetings, IT-based helpdesk conference calls (e.g., assistance during a purchase process), and so on. Moreover, those skilled in the art would recognize that in some VoIP systems the call path may be established end-to-end between the caller and the callee (e.g., between the IVA and the user) rather than via the call manager, and the description above is meant as an illustrative example of one configuration, and not as a limitation to the present disclosure.

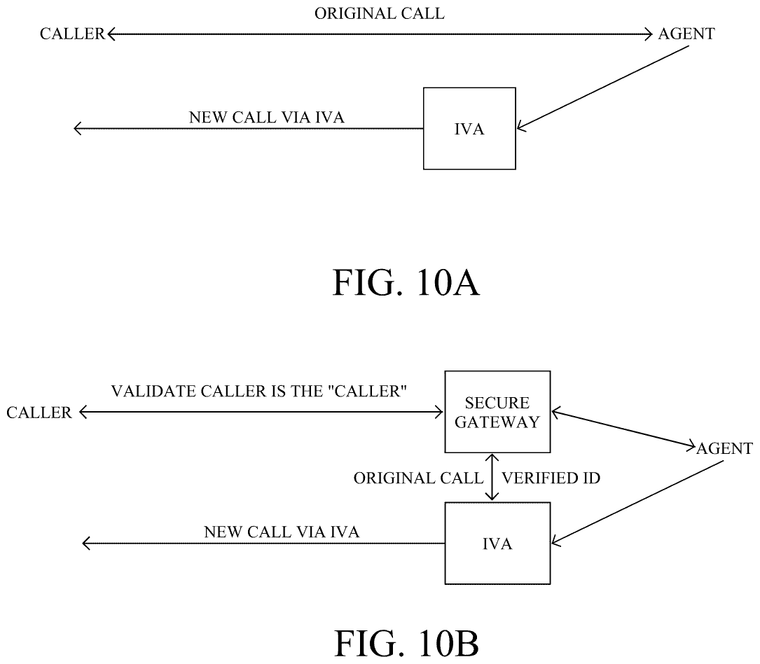

Also, while certain devices and network configurations have been shown, other configurations may be made with similar results, whether having more devices participating with separate functionalities or fewer devices with greater responsibilities. FIGS. 10A-10B, for example, illustrate further simplified examples of secure voice payment systems herein that don't specifically include a call manager (CM). For example, in FIG. 10A, the user calls the agent directly, while in FIG. 10B, the user calls into a secure gateway, a device/server that can verify the attested identity of the user (and share the verification, accordingly). In both FIGS. 10A-10B, while in the call, payment is required. The agent can push a digital link for payment or else have a secure call placed to user which allows for voice-based payment. If the customer chooses voice, the agent pushes a button, and a new call is initiated by the IVA, as described above. The customer accepts the call and talks to the IVA providing the info, the IVA provides status of payment to Agent (w/o) details. The IVA may also provide the caller's sentiment (frustration, etc.). Alternatively, if the agent sees an issue status, he/she can end the IVA call and reclaim the original call. When the payment is successful, the IVA ends the call thus returning the caller to the original call.

Similarly, when the call goes through the secure gateway, which verifies the user's identity through a secure zero knowledge attestation process, and a payment is required, the agent can push a digital link for payment or else have a secure call placed to user which allows for voice-based payment. If the customer chooses voice, the agent pushes a button, and a new call is initiated by the IVA, as described above. The customer accepts the call and talks to the IVA providing the info, the IVA provides status of payment to Agent (w/o) details. The IVA may also provide the caller's sentiment (frustration, etc.). Alternatively, if the agent sees an issue status, he/she can end the IVA call and reclaim the original call. When the payment is successful, the IVA ends the call thus returning the caller to the original call.

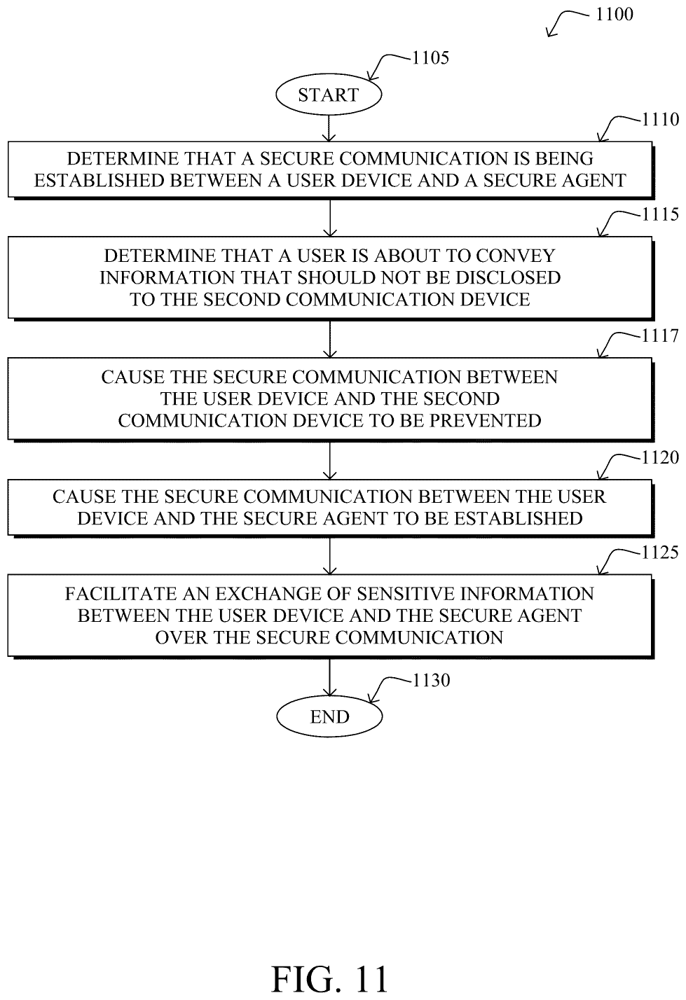

FIG. 11 illustrates an example procedure for secure voice payments for call-based transactions. For example, a non-generic, specifically configured device (e.g., device 900, an apparatus) may perform procedure 1100 by executing stored instructions (e.g., process 948). The procedure 1100 may start at step 1105, and continues to step 1110, where, as described in greater detail above, the procedure 1100 includes determining, by a secure gateway and during a communication between a user device and a second communication device on a first communication channel, that a secure communication is being established between the user device and a secure agent. In some implementations, the second communication device can be a merchant device or a user device, depending on the initiation of communication between various devices, as discussed above.

The procedure 1100 continues to step 1115 where, as discussed in greater detail above, the procedure 1100 includes determining, by the secure gateway, that an identity of a user associated with the user device is verified by a verification service.

The procedure 1100 continues to step 1117 where, as discussed in greater detail above, the procedure 1100 includes causing, by the secure gateway, the secure communication between the user device and the second communication device to be prevented.

The procedure 1100 continues to step 1120 where, as discussed in greater detail above, the procedure 1100 includes causing, by the secure gateway, the secure communication between the user device and the secure agent to be established. In some implementations, the procedure 1100 can include terminating the first communication channel in response to establishing the secure communication.

The procedure 1100 continues to step 1125 where, as discussed in greater detail above, the procedure 1100 includes facilitating, via the secure gateway, an exchange of sensitive information between the user device and the secure agent over the secure communication. In some implementations, the sensitive information can include information associated with the user to complete a transaction, such as personally identifying information (PII). In such implementations, the secure agent comprises a secure payment agent and/or a collector of personally identifying information agent, and the information associated with the user comprises payment information, and the transaction comprises a purchase of a good or a service.

The procedure 1100 can further include determining, by the secure agent, that the exchange of sensitive information between the user device and the secure agent is complete; and, in response, terminating, by the secure agent, the communication from the user device. Implementations are not so limited, however, and in some implementations, the procedure 1100 can include determining, by the secure agent, that the exchange of sensitive information between the user device and the secure agent is incomplete; re-establishing the first communication channel; and transferring the communication from the user device back to the second communication device on the first communication channel.

In some implementations, the user device initiates the communication with the second device through a call manager device that forwards the communication to the second device over the first communication channel, although implementations are not limited to such scenarios.

The procedure 1100 may further include obfuscating, from the second communication device, the sensitive information of the user device.

The procedure 1100 may include providing the sensitive information as encrypted information that is unreadable by the second communication device and the secure agent. In such implementations, the procedure 1100 may further include providing the sensitive information as encrypted information that is unreadable by the second communication device, the secure agent, and the secure gateway. In addition to, or in the alternative, a public key of the user is compared to the encrypted information to verify the sensitive information discussed herein.

In some implementations, the procedure 1100 can include maintaining a communication between the user device and the second communication device while the user device is in communication with the secure agent, while ensuring that the second communication device is not privy to communication between the user device and the secure agent. In such implementations, the procedure may include sending, to the user device, a link to initiate communication between the user device and the secure agent.

Procedure 1100 may end at step 1130.

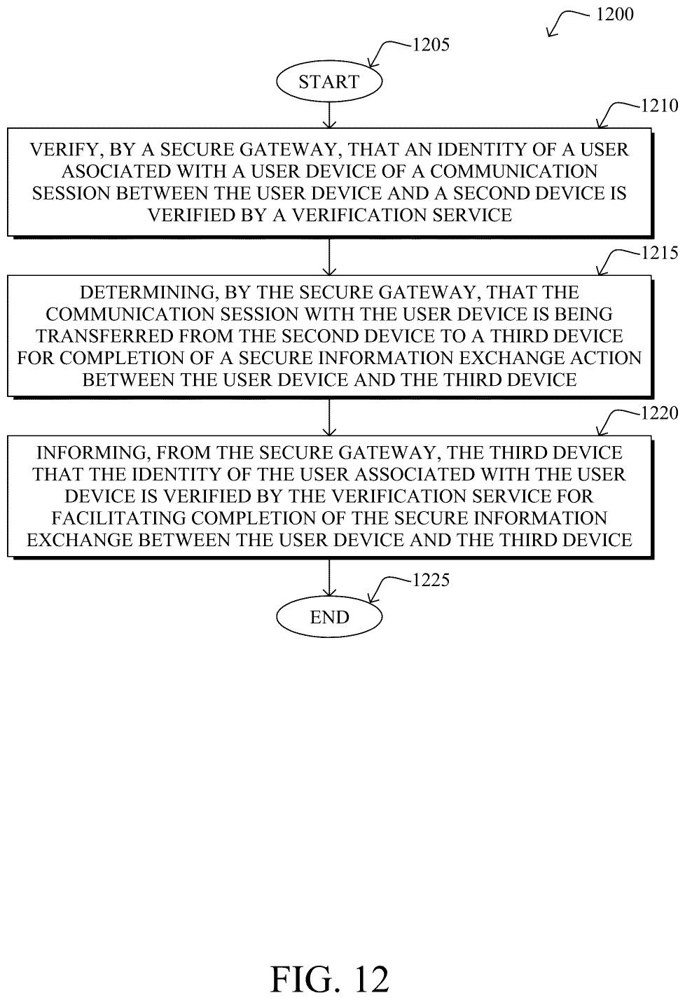

FIG. 12 illustrates another example procedure for secure voice payments for call-based transactions. For example, a non-generic, specifically configured device (e.g., device 900, an apparatus) may perform procedure 1200 by executing stored instructions (e.g., process 948). The procedure 1200 may start at step 1205, and continues to step 1210, where, as described in greater detail above a secure gateway verifies that an identity of a user associated with a user device of a communication session between the user device and a second device is verified by a verification service. In some implementations, the verification service comprises an attestation service that verifies an identity of the user through a secure zero knowledge attestation process, as discussed above.

The procedure 1200 continues to step 1215 where, as discussed in greater detail above, the procedure 1200 includes determining, by the secure gateway, that the communication session with the user device is being transferred from the second device to a third device for completion of a secure information exchange (e.g., a “secure action”) between the user device and the third device. As discussed herein, the third device can be a secure agent (e.g., an IVA). In such implementations, the secure agent can be a secure payment processing service.

The procedure 1200 continues to step 1220 where, as discussed in greater detail above, the procedure 1200 includes informing, from the secure gateway, the third device that the identity of the user associated with the user device is verified by the verification service for facilitating completion of the secure information exchange between the user device and the third device. As discussed herein, the secure information exchange can involve a payment for a good or a service, although implementations are not so limited.

In some implementations, the procedure 1200 can include providing an indication from the third device to one of the second device and the secure gateway, that the secure information exchange between the user device and the third device is complete. As described herein, the secure gateway can be in communication with an application running on the user device, and the secure gateway can be in selective communication with the second device and the third device. However, as discussed herein, information regarding the user of the user device may be obfuscated from the second device and the third device, or other devices, in order to facilitate the zero knowledge protection of the user information disclosed herein.

In some implementations, the secure gateway can operate as an intermediary device between user device and second device when the user device is verified by the verification service. In such implementations, the secure gateway provides verification that the identity of the user associated with the user device is verified by the verification service to a third device and the third device initiates a call to with the user device based on the verification that the identity of the user associated with the user device is verified by the verification service provided by the secure gateway. In addition to, or in the alternative, the secure gateway can provide an indication to the user device to accept a communication from the third device in response to the user device being transferred from the second device to the third device.

As discussed above, in some implementations, the communication session between the user device and the second device is a voice communication and the communication session between the user device and the third device is a voice communication. Implementations are not so limited, however, and in some implementations, the communication session between the user device and the second device is a voice communication and the communication session between the user device and the third device is initiated via a uniform resource locator link, such as a website, QR code, or other internet accessible link.

In some implementations, the procedure 1200 can include providing, to the third device, secure identity information regarding the verified user of the user device to facilitate completion of the secure information exchange between the user device and the third device, wherein the secure gateway is unable to access the secure identity information regarding the verified user of the user device. In such implementations, the secure identity information regarding the verified user of the user device comprises payment information associated with the verified user of the user device.

The procedure 1200 may further include re-establishing the communication session back to the second device in response to completion of the secure information exchange between the user device and the third device, terminating the communication session in response to completion of the secure information exchange between the user device and the third device, re-establishing the communication session back to the second device in response to an indication that the secure information exchange between the user device and the third device is not completed, re-establishing, and/or transferring the communication session back to the second device in response to a request from the user device.

Procedure 1200 may end at step 1225.

In some implementations, an illustrative apparatus herein may comprise: one or more network interfaces to communicate on a plurality of communication channels; a processor adapted to execute one or more processes; and a memory configured to store a process executable by the processor, the process when executed operable to perform a method comprising: determining, by a secure gateway and during a communication between a user device and a second communication device on a first communication channel, that a secure communication is being established between the user device and a secure agent; determining, by the secure gateway, that a user is about to convey information that should not be disclosed to the second communication device; causing, by the secure gateway, the secure communication between the user device and the second communication device to be prevented; causing, by the secure gateway, the secure communication between the user device and the secure agent to be established; and facilitating, via the secure gateway, an exchange of sensitive information between the user device and the secure agent over the secure communication.

In some implementations, an illustrative apparatus herein may comprise: one or more network interfaces to communicate on a plurality of communication channels; a processor adapted to execute one or more processes; and a memory configured to store a process executable by the processor, the process when executed operable to perform a method comprising: verifying, by a secure gateway, that an identity of a user associated with a user device of a communication session between the user device and a second device is verified by a verification service; determining, by the secure gateway, that the communication session with the user device is being transferred from the second device to a third device for completion of a secure information exchange between the user device and the third device; informing, from the secure gateway, the third device that the identity of the user associated with the user device is verified by the verification service for facilitating completion of the secure information exchange between the user device and the third device.

The foregoing description has been directed to specific embodiments. It will be apparent, however, that other variations and modifications may be made to the described embodiments, with the attainment of some or all of their advantages. For instance, it is expressly contemplated that certain components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

What is claimed is:

1. A method, comprising:
determining, by a secure gateway and during a communication between a user device and a second communication device on a first communication channel, that a secure communication is being established between the user device and a secure agent;
determining, by the secure gateway, that a user is about to convey information that should not be disclosed to the second communication device;
causing, by the secure gateway, the secure communication between the user device and the second communication device to be prevented;
causing, by the secure gateway, the secure communication between the user device and the secure agent to be established; and
facilitating, via the secure gateway, an exchange of sensitive information between the user device and the secure agent over the secure communication.

2. The method of claim 1, wherein the sensitive information comprises information associated with the user to complete a transaction.

3. The method of claim 2, wherein:
the secure agent comprises a secure payment agent,
the information associated with the user comprises payment information, and
the transaction comprises a payment for a good or a service.

4. The method of claim 1, wherein the sensitive information comprises personally identifying information.

5. The method of claim 1, further comprising:
determining, by the secure agent, that the exchange of sensitive information between the user device and the secure agent is complete; and
terminating, by the secure agent, the communication from the user device in response to the exchange of sensitive information between the user device and the secure agent being complete.

6. The method of claim 1, further comprising:
determining, by the secure agent, that the exchange of sensitive information between the user device and the secure agent is incomplete;
re-establishing the first communication channel; and
transferring the communication from the user device back to the second communication device on the first communication channel or a third communication channel.

7. The method of claim 1, wherein:
the second communication device comprises a merchant device.

8. The method of claim 1, wherein:
the user device initiates the communication with the second communication device through a call manager device that forwards the communication to the second communication device over the first communication channel.

9. The method of claim 1, further comprising:
obfuscating, from the second communication device, the sensitive information conveyed from the user device.

10. The method of claim 1, further comprising:
providing the sensitive information as encrypted information that is unreadable by the second communication device and the secure agent.

11. The method of claim 10, further comprising:
providing the sensitive information as encrypted information that is unreadable by the second communication device, the secure agent, and the secure gateway.

12. The method of claim 10, wherein a public key of the user is compared to the encrypted information to verify the sensitive information.

13. The method of claim 1, further comprising:
maintaining a communication channel between the user device and the second communication device while the user device is in communication with the secure agent, while ensuring that the second communication device is not privy to communication between the user device and the secure agent.

14. The method of claim 1, further comprising:
sending, to the user device, a link to initiate communication between the user device and the secure agent.

15. A method, comprising:
verifying, by a secure gateway, that an identity of a user associated with a user device of a communication session between the user device and a second device is verified by a verification service;
determining, by the secure gateway, that the communication session with the user device is being transferred from the second device to a third device for completion of a secure information exchange between the user device and the third device; and
informing, from the secure gateway, the third device that the identity of the user associated with the user device is verified by the verification service for facilitating completion of the secure information exchange between the user device and the third device.

16. The method of claim 15, wherein the verification service comprises an attestation service that verifies an identity of the user through a secure zero knowledge attestation process.

17. The method of claim 15, wherein the third device comprises a secure agent.

18. The method of claim 17, wherein the secure agent comprises one or more of a secure payment processing service, and a collector of personally identifying information agent.

19. The method of claim 15, wherein the secure gateway is in communication with an application running on the user device, and wherein the secure gateway is in selective communication with the second device and the third device.

20. The method of claim 15, wherein:
the secure gateway operates as an intermediary device between user device and second device when the user device is verified by the verification service,
the secure gateway provides verification that the identity of the user associated with the user device is verified by the verification service to a third device, and
the third device initiates a call to the user device based on the verification that the identity of the user associated with the user device is verified by the verification service provided by the secure gateway.

21. The method of claim 15, wherein the secure gateway provides an indication to the user device to accept a communication from the third device in response to the third device being instructed to place a call to the user device.

22. The method of claim 15, further comprising:
providing an indication from the third device to one of the second device and the secure gateway, that the secure information exchange between the user device and the third device is complete.

23. The method of claim 15, wherein:
the communication session between the user device and the second device is a voice communication, and
the communication session between the user device and the third device is one or more of a voice communication, digital communication, and a signaling communication.

24. The method of claim 15, wherein:
the communication session between the user device and the second device is a voice communication, and
the communication session between the user device and the third device is initiated via a uniform resource locator link.

25. The method of claim 15, further comprising:
providing, to the third device, secure identity information regarding a verified user of the user device to facilitate completion of the secure information exchange between the user device and the third device, wherein the secure gateway is unable to access the secure identity information regarding the verified user of the user device.

26. The method of claim 25, wherein the secure identity information regarding the verified user of the user device comprises one or more of a payment information associated with the verified user of the user device and personally identifying information associated with the verified user of the user device.

27. The method of claim 15, further comprising:
re-establishing the communication session back to the second device in response to completion of the secure information exchange between the user device and the third device.

28. The method of claim 15, further comprising:
terminating the communication session in response to completion of the secure information exchange between the user device and the third device.

29. The method of claim 15, further comprising:
re-establishing the communication session back to the second device in response to an indication that the secure information exchange between the user device and the third device is not completed.

30. The method of claim 15, further comprising:
re-establishing the communication session back to the second device in response to a request from the user device.

31. The method of claim 15, wherein the secure information exchange involves one or more of a purchase of a good or a service and conveying personally identifying information.

32. The method of claim 15, further comprising:
obfuscating, from the second device and the third device, information regarding the user of the user device.

33. An apparatus, comprising:
one or more network interfaces to communicate on a plurality of communication channels;
a processor adapted to execute one or more processes; and
a memory configured to store a process executable by the processor, the process when executed operable to perform a method comprising:
determining, by a secure gateway and during a communication between a user device and a second communication device on a first communication channel, that a secure communication is being established between the user device and a secure agent;
determining, by the secure gateway, that a user is about to convey information that should not be disclosed to the second communication device;
causing, by the secure gateway, the secure communication between the user device and the second communication device to be prevented;
causing, by the secure gateway, the secure communication between the user device and the secure agent to be established; and
facilitating, via the secure gateway, an exchange of sensitive information between the user device and the secure agent over the secure communication.

34. An apparatus, comprising:
one or more network interfaces to communicate on a plurality of communication channels;
a processor adapted to execute one or more processes; and
a memory configured to store a process executable by the processor, the process when executed operable to perform a method comprising:
verifying, by a secure gateway, that an identity of a user associated with a user device of a communication session between the user device and a second device is verified by a verification service;
determining, by the secure gateway, that the communication session with the user device is being transferred from the second device to a third device for completion of a secure information exchange between the user device and the third device; and
informing, from the secure gateway, the third device that the identity of the user associated with the user device is verified by the verification service for facilitating completion of the secure information exchange between the user device and the third device.
